(19) United States
(12) Patent Application Publication
(10) Pub. No.: US 2015/0019180 A1
(43) Pub. Date: Jan. 15, 2015

(54) Model Replacement in a Local Region by Inversion

(71) Applicant: Jonathan Liu, Sugar Land, TX (US)

(72) Inventor: Jonathan Liu, Sugar Land, TX (US)

(21) Appl. No.: 14/311,049

(22) Filed: Jun. 20, 2014

Related U.S. Application Data
(60) Provisional application No. 61/845,869, filed on Jul. 12, 2013.

(51) Int. Cl. G06F 17/50

(52) U.S. Cl. CPC G06F 17/50
USPC 703/2

(57) ABSTRACT

Method for reconstructing a local region (20) of a physical property model (10), such as a velocity model, by inversion (80) of geophysical data, such as seismic data, wherein the magnitude of the gradient of the model parameter is minimized (70) within the local region subject to enforcing the continuity of the model on the boundary (60) of the local region. The inversion is preferably implemented on 2D depth slices of the model, one depth slice at a time (50). To improve computer efficiency in extracting the depth slices, the three-dimensional model may first be remapped from its original orientation to one in which the depth dimension is the slowest accessed by the computer in reading the data (30).

### CROSS-REFERENCE TO RELATED APPLICATION

This application claims the benefit of U.S. Provisional Patent Application 61/845,869, filed Jul. 12, 2013, entitled MODEL REPLACEMENT IN A LOCAL REGION BY INVERSION, the entirety of which is incorporated by reference herein.

### FIELD OF THE INVENTION

This disclosure relates generally to the field of geophysical prospecting and, more particularly, to velocity model building in seismic data processing. Specifically, the disclosure relates to a method for replacing the model for velocity or other physical property in a local region.

### BACKGROUND OF THE INVENTION

A need can arise to reconstruct a portion of a subsurface velocity model. This typically happens in tomographic inversion where local anomalies or artifacts are detected and the model needs to be edited locally. For example, it may be desirable to have a pure sediment velocity model for a region containing salt bodies. Or, the velocity model may have a region containing obviously bad values. The following two publications attempt to solve the same or similar technical problem by interpolation.

1. Scattered Data Interpolation (Shepard Method)

This method [Shepard, 1968] reconstructs a continuous function from sample points with weighting functions based on the distance to the grid points. The method is a global method and hence computationally expensive. The main drawback of the Shepard method is that the data being interpolated are in general not particularly smooth.

2. Scattered Data Interpolation (With Radial Basis Functions)

This method [Dyn, 1989] tries to improve the Shepard method by using radial basis functions to replace the weighting functions in the Shepard method. A solution based on preconditioning the matrix has been suggested. However, the preconditioning technique is generally high in computational cost.

### SUMMARY OF THE INVENTION

In one embodiment, the invention is a method for reconstructing values of a physical property model parameter in a local region of the model so as to be consistent with model values outside the local region, comprising minimizing, by iterative numerical optimization performed using a computer, an objective function that is a measurement of smoothness of the model inside the local region, subject to a boundary condition whereby the model parameter is continuous when crossing a boundary of the local region; wherein the optimization comprises inversion of measured geophysical data.

The absolute value of the gradient of the model parameter is a preferred but non-limiting objective function. In another preferred embodiment, the optimization (inversion) is performed on the model one depth slice at a time. To facilitate access by the computer to constant-depth data in performing the inversion, the 3-D model may first be remapped to an orientation in which depth is the slowest-accessed dimension.

### BRIEF DESCRIPTION OF THE DRAWINGS

The present invention and its advantages will be better understood by referring to the following detailed description and the attached drawings in which:

FIG. 1 is a flow chart showing basic steps in one embodiment the present inventive method;

FIG. 2 shows a velocity model of a subsurface region that contains a salt body;

FIG. 3 shows the local region to define the salt body where the velocity will be replaced;

FIG. 4 shows a depth slice of the velocity model;

FIG. 5 shows the same depth slice of the region;

FIG. 6 shows the velocity model whose values in the local region have been replaced with sediment velocity, shown in depth slice; and

FIG. 7 shows the velocity model whose values in the local region have been reconstructed with sediment velocity.

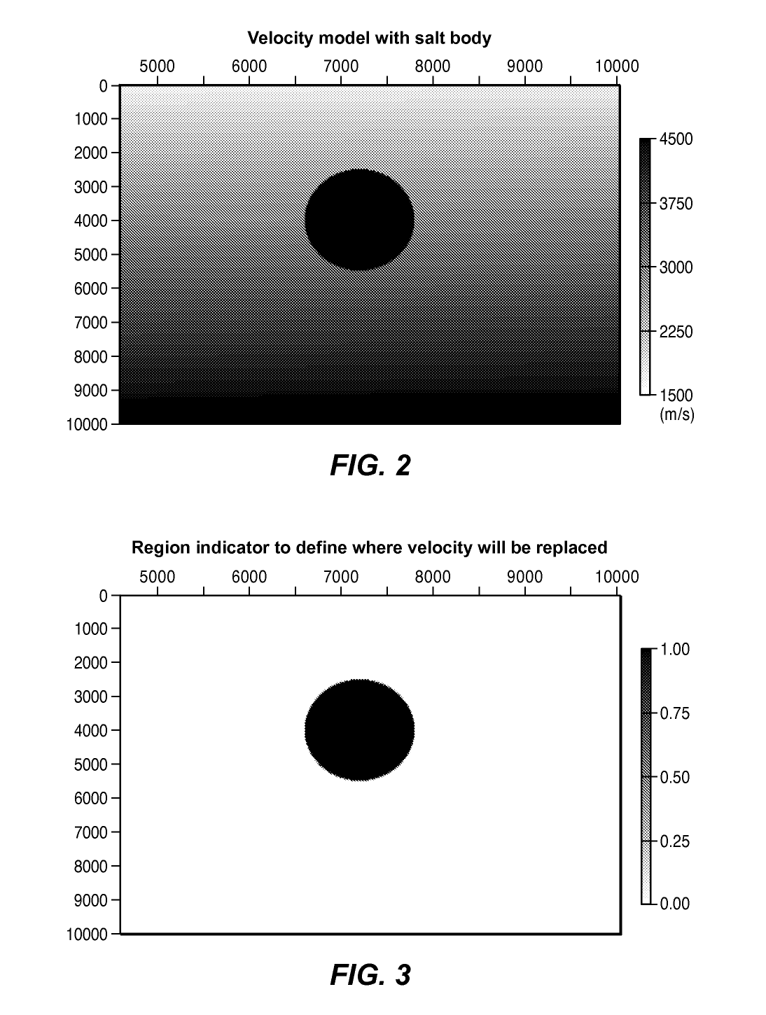

Due to patent law restrictions on the use of color, FIGS. 2-7 are conversions of color originals to a gray scale.

The invention will be described in connection with example embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims.

### DETAILED DESCRIPTION OF EXAMPLE EMBODIMENTS

The present inventive method uses values of the model on the boundary grid points of a selected local region of interest to reconstruct the model inside the region, which reduces computational cost dramatically in comparison to methods that use the values of the model outside the region. In order to obtain a smooth reconstructed function, the present invention uses an objective (optimization) function that is a measurement of the smoothness of the model inside the region. In a preferred embodiment of the invention, the magnitude of the gradient of the model parameter is the optimization function. The gradient is represented by the first-order derivatives of a function in all dimensions. In general, the smaller gradient is, the smoother a function is. In another embodiment of the invention, for example, the magnitude of the second-order derivatives of the model may be used. To keep the continuity of the model at the edge of the region, the boundary condition is enforced. The optimization objective function described above is equivalent to a linear algebraic equation system. In addition, one embodiment of the invention decomposes a model of a 3D volume into 2D depth slices and works on individual slices. In this way, both efficiency and stability are achieved.

Let v(x,y,z) be the original velocity model, S is a local region where the velocity will be replaced, and u(x,y,z) is the updated velocity model, then the inversion problem may be expressed as:

minimizing ∥∇u∥², inside S (1)

u(x,y,z)=v(x,y,z), on δS (2)

where δS is the surface of S that defines the boundary of S. Compared to conventional approaches, the present inventive method uses only the model values on the boundary of S to reconstruct the model inside S, which results in superior computational efficiency. The optimization objective function above is equivalent to a linear algebraic equation system, which may preferably be solved by algorithms for solving linear sparse algebraic equation systems (e.g. Paige and Saunders (1982)). The objective function in (1) may use norms other than the L₂ norm shown. When a 3D local region is large, this equation system may have a stability problem that slows down any solver of linear algebraic equation systems. To resolve the stability issue, a preferred embodiment of the present invention decomposes a model of a 3D volume into 2D depth slices and works on individual slices. In this way, both efficiency and stability are achieved. A trade-off is the reconstructed model has less smoothness in the depth direction, but this is tolerable for most geophysical applications where the smoothness in the depth direction is not as important as in the lateral directions.

For further increase in computational efficiency, in preferred embodiments of the invention, it is noted that the orientation of a multi-dimensional array of numbers will affect the efficiency with which a computer can access the array on a disk or in a memory. Using a 2-D array as an example, suppose that A=[aij] is a matrix (2D array). Usually, A is stored in a disk, row-by-row, and users can get a row from A quickly as the data is read continuously from the disk. However, if users want to get a column from A, the data reading has to be interrupted and, therefore the operation will be slow. To read a column from A quickly, one can switch the indices of A and store A on a disk column by column.

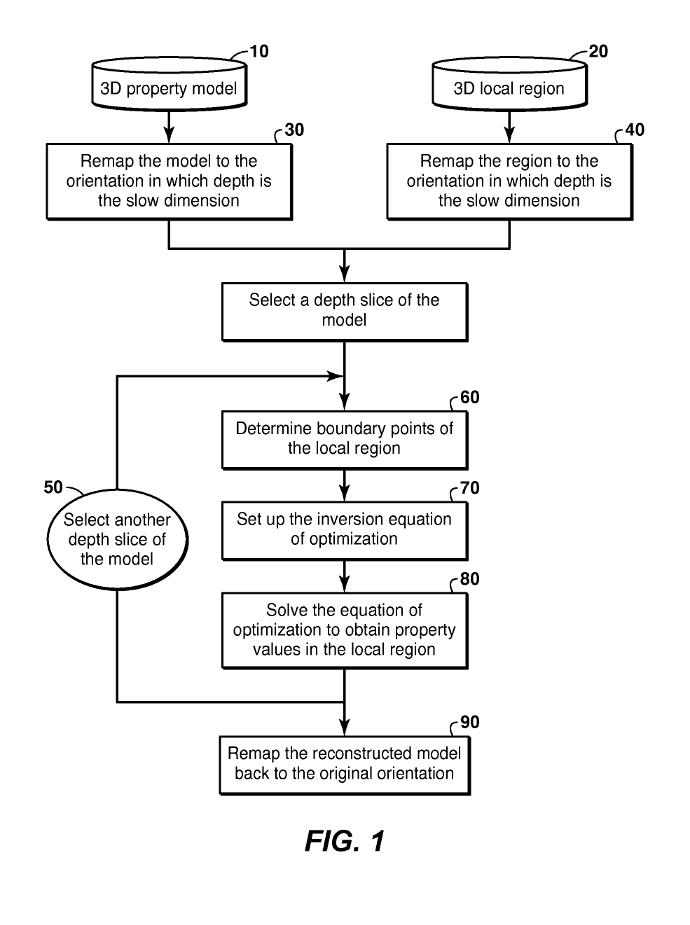

Applying this technique to the embodiment of the present invention in which the inversion is performed one depth slice at a time, since depth will be held constant for each slice, the model is first remapped so that depth is the slow-access dimension (step 30 in FIG. 1). Thus, the other two dimensions, which are the ones that have to be accessed for a constant-depth slice, are faster accessed. Similarly, the region definition 20 is remapped so that depth is the slow dimension (step 40 in FIG. 1). Then, after the computer has performed the inversion (steps 50-80), the reconstructed model may be mapped back to the original orientation (step 90).

Because the invention uses the values of the property model on the boundary of the region to reconstruct the model inside the region, the model must preferably be continuous outside the region, or at least in the area close to the boundary of the region.

### Examples

The present invention was tested both on synthetic data and on field data. Following is a description of a synthetic data test.

FIG. 2 shows a velocity model of a subsurface region that contains a salt body.

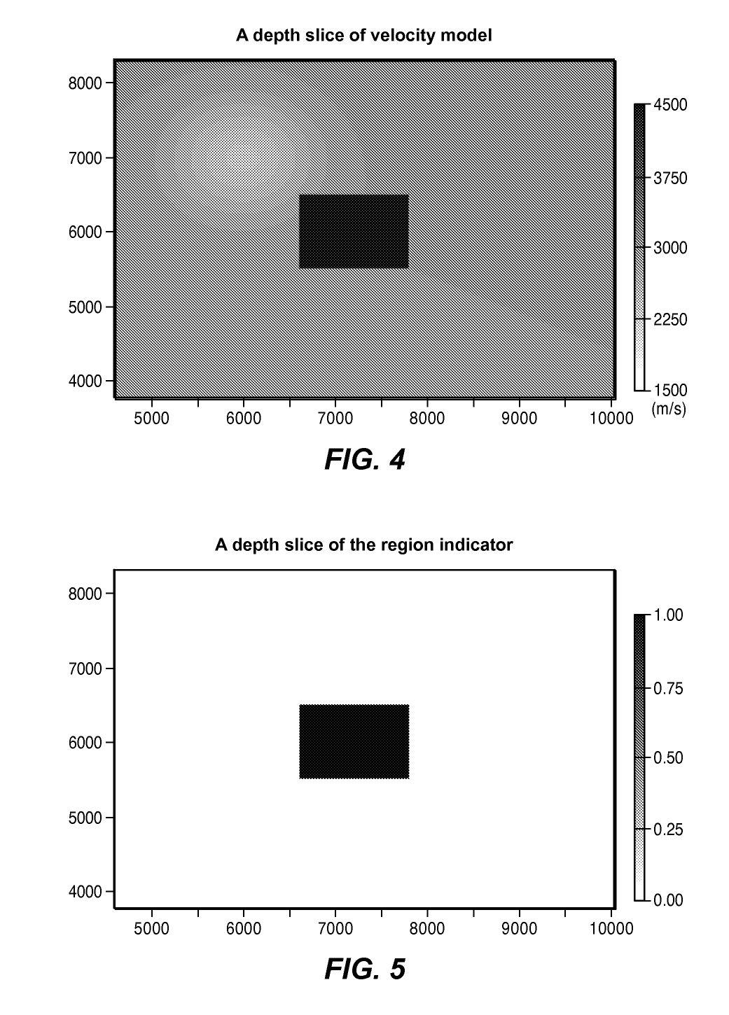

In FIG. 2, depth is plotted on the vertical axis (z), and the other axis (x) is a horizontal dimension. The salt body is a cylinder with axis of symmetry parallel to the y-axis. Referring to the flow chart of FIG. 1, this velocity model is an example of the 3-D property model 10. FIG. 3 shows the local region to define the salt body where the velocity will be replaced, referred as 20 in FIG. 1. In FIG. 3, the gray scale does not display velocity, but rather indicates where the local region that will be replaced is. The value 1 (dark blue in the original color drawing) indicates that a point belongs to the local region, and the value 0 (red in the original color drawing) indicates that a point is outside of the local region. FIG. 4 shows a depth slice at depth 4,000 m of the velocity model, which may be advantageously remapped so that depth is the slow dimension (step 30 in FIG. 1). The vertical axis in the drawing is now the y-axis. FIG. 5 shows the same depth slice of the local region definition volume, which may also be remapped so that depth is the slow dimension (step 40 in FIG. 1).

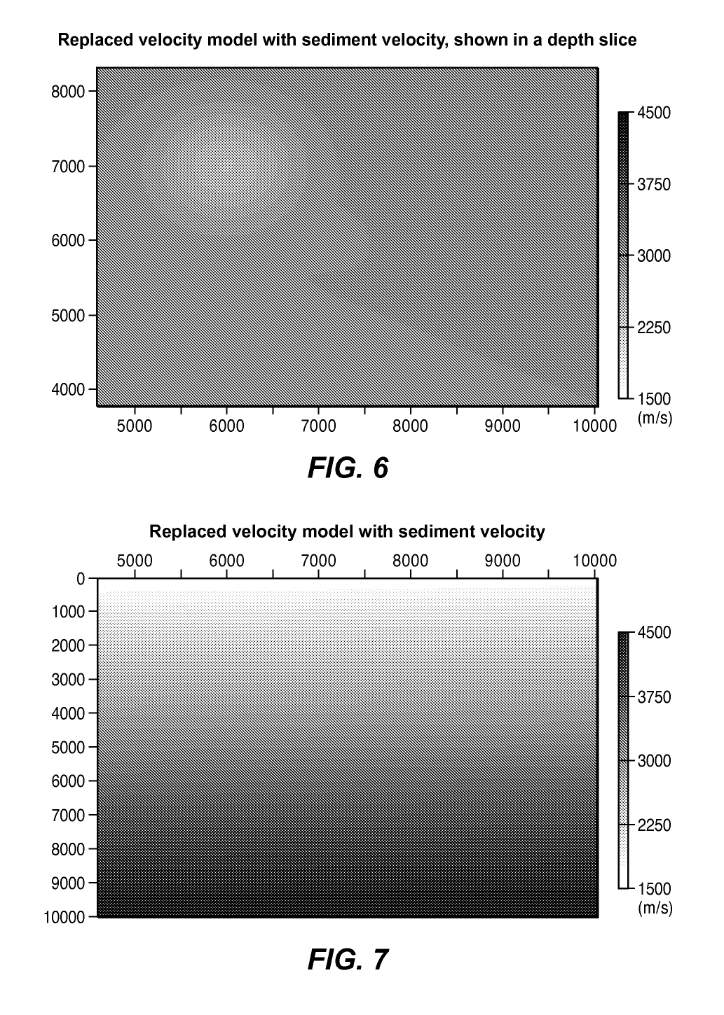

After determining the boundary points of the local region (step 60), and (step 70) setting up the inversion equation (1) and (step 80) solving it while enforcing the boundary condition (2), the result is shown in FIG. 6. That is, FIG. 6 shows in depth slice the model whose values in the local region have been replaced with sediment velocity. After repeating (step 50) steps 60-80 for each depth slice in the model, the reconstructed depth slices are put back together into a 3-D model (90), and mapped back to the original orientation, as shown in

FIG. 7, with sediment replacing the salt body of FIG. 2.

As one example of a use for the present invention, sometimes the salt body geometry is erroneous and needs to be reshaped. The reconstructed sediment velocity of FIG. 7 can be used in a sediment velocity flood migration to reshape the salt body geometry.

The foregoing application is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims. Persons skilled in the art will readily recognize that in preferred embodiments of the invention, at least some of the steps in the present inventive method are performed on a computer, i.e. the invention is computer implemented.

References

1. Paige, C. C., and Saunders, M. A., “LSQR: An algorithm for sparse linear equations and sparse least squares: Transactions on Mathematical Software 8(1),” 43-71 (1982).

2. Shepard, D., “A two-dimension interpolations function for irregularly spaced data: Proceedings of the 23rd National Conference of the Association for Computing Machinery,” 517-523 (1968).

3. Dyn, N., Interpolation and approximation by radial and related functions: Approximation Theory VI, Vol. 1, Academic Press, 211-234 (1989).

1. A method for reconstructing values of a physical property model parameter in a local region of the model so as to be consistent with model values outside the local region, comprising:
minimizing, by iterative numerical optimization performed using a computer, an objective function that is a measurement of smoothness of the model inside the local region, subject to a boundary condition whereby the model parameter is continuous when crossing a boundary of the local region;
wherein the optimization comprises inversion of measured geophysical data.

2. The method of claim 1, wherein the inversion comprises using a model of the local region to simulate synthetic geophysical data, comparing the synthetic geophysical data to the measured geophysical data, and updating the model from the local region to minimize misfit.

3. The method of claim 2, wherein the model is three-dimensional, and further comprising selecting a plurality of two-dimensional depth slices from the three-dimensional model, and performing the minimizing one slice at a time, and then putting the updated slices back together to form a reconstructed three-dimensional model.

4. The method of claim 3, wherein to facilitate access to constant-depth slices by the computer, the three-dimensional model is first remapped from its original orientation to one in which the depth dimension is the slowest accessed.

5. The method of claim 4, wherein the local region is defined for the optimization by a three-dimensional local region identification volume and the local region identification volume is also remapped so that the depth dimension is the slowest accessed by the computer.

6. The method of claim 5, wherein the reconstructed three-dimensional model is mapped back to its original orientation.

7. The method of claim 1, wherein the objective function is absolute value of gradient of the model parameter.

8. The method of claim 1, wherein the objective function is absolute value of second-order spatial derivatives of the model parameter.

9. The method of claim 1, wherein the minimizing by iterative numerical optimization is performed by an algorithm for sparse linear equations and sparse least squares.
